(19) United States
(12) Patent Application Publication
(10) Pub. No.: US 2026/0044929 A1
(43) Pub. Date: Feb. 12, 2026

(54) TRAINED-MODEL GENERATING METHOD, IMAGE PROCESSING METHOD, IMAGE PROCESSING APPARATUS, AND STORAGE MEDIUM

(71) Applicant: CANON KABUSHIKI KAISHA, Tokyo (JP)

(72) Inventors: Masakazu KOBAYASHI, Tokyo (JP); Norihito HIASA, Tochigi (JP)

(21) Appl. No.: 19/262,505

(22) Filed: Jul. 8, 2025

(30) Foreign Application Priority Data
Aug. 9, 2024 (JP) 2024-133782

(51) Int. Cl. G06T 3/4046

(52) U.S. Cl. CPC G06T 3/4046

(57) ABSTRACT

A method for generating a trained model includes acquiring a training image and a ground truth image, inputting the training image into a machine learning model to generate an output image, acquiring a weighting coefficient, calculating a loss using the ground truth image, the output image, and the weighting coefficient, and updating a parameter of the machine learning model based on the loss. The weighting coefficient changes according to at least one of a signal value of the training image, a signal value of the ground truth image, and a signal value of the output image.

### BACKGROUND

### Field of the Technology

The present disclosure relates to a trained-model generating method, an image processing method, an image processing apparatus, and a storage medium.

### Description of the Related Art

X. Mao, C. Shen, Y. Yang, “Image Restoration Using Convolutional Auto-encoders with Symmetric Skip Connections,” https://arxiv.org/abs/1606.08921, discloses a network configuration generally applicable to a variety of regression problems. This reference also discloses upsampling of an input image, JPEG deblocking (removal of compression noise), denoising, non-blind deblurring, or inpainting using a network to perform.

### SUMMARY

One or more embodiments of a method for generating a trained model according to one or more aspects of the present disclosure may include acquiring a training image and a ground truth image, inputting the training image into a machine learning model to generate an output image, acquiring a weighting coefficient, calculating a loss using the ground truth image, the output image, and the weighting coefficient, and updating a parameter of the machine learning model based on the loss. The weighting coefficient changes according to at least one of a signal value of the training image, a signal value of the ground truth image, and a signal value of the output image. An image processing method includes generating an estimated image based on an input image. The estimated image is generated using the trained model. An image processing apparatus using the trained model acquired by the above method also constitutes another aspect of the present disclosure. A storage medium storing a program that causes a computer to execute the above method also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 illustrates the configuration of a machine learning model according to Example 1.

FIG. 2 is a block diagram of an image processing system according to Example 1.

FIG. 3 is an external view of the image processing system according to Example 1.

FIG. 4 is a flowchart of training processing for the machine learning model according to Example 1.

FIG. 5 explains gamma correction according to Examples 1 and 2.

FIG. 6 illustrates a relationship between a signal value and a weighting coefficient (or factor) according to Examples 1 and 2.

FIGS. 7A and 7B explain a signal value and a weighting coefficient according to Examples 1 and 2.

FIG. 8 is a flowchart of estimation processing for the machine learning model according to Examples 1 and 2.

FIG. 9 is a block diagram of an image processing system according to Example 2.

FIG. 10 is an external view of the image processing system according to Example 2.

FIG. 11 is a flowchart of training processing for a machine learning model according to Example 2.

FIG. 12 illustrates a relationship between a difference between a ground truth image and an output image and a weighting coefficient according to Example 2.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of examples according to the present disclosure. Corresponding elements in respective figures will be designated by the same reference numerals, and a duplicate description thereof will be omitted.

In the following description, image processing using a machine learning model involves two types of processing: processing for updating a parameter (such as weight and bias) and processing for making an estimate for an unknown input using the updated parameter. Hereinafter, the former will be referred to as training processing, and the latter will be referred to as estimation processing. Each example may have a characteristic in the training processing. A value serving as an index for updating the parameter for the machine learning model will be referred to as a loss (error), and a value obtained by simply subtracting images will be referred to as a difference. In the training processing, the machine learning model updates the parameter so as to minimize the loss.

Next, images for the training processing and the estimation processing will be identified. An image input to the machine learning model will be referred to as an input image, and an input image with a known ground truth image that is used in particular for the training processing will be referred to as a training image. An image output from the network will be referred to as an output image, and an output image in the estimation processing will be referred to as an estimated image. The input image, output image, and ground truth image are raw images, and are images that have not received gamma correction.

Here, a raw image is undeveloped image data output from an image sensor, and a light amount and a signal value of each pixel have an approximately linear relationship. The raw image is developed before the user views it, and gamma correction is performed for it in the development. Gamma correction is, for example, processing of raising the input signal value to power, and 1/2.2 being used as the exponent.

Before a detailed description of each example is provided, the gist of each example will be given. Each example may consider the influence of gamma correction in the training processing for a machine learning model that inputs a raw image. Thereby, an estimated image after development can maintain a roughly constant estimation accuracy regardless of the magnitude of the signal value. In particular, undershoot and ringing that tend to occur with high resolution (upsampling and deblurring) are suppressed. Machine learning models include, for example, Convolutional Neural Network (CNN), Generative Adversarial Network (GAN), and diffusion models. As a method of considering gamma correction during training, each example determines a weighting coefficient based on at least one signal value of a ground truth image, an output image, and a training image, and calculates a loss (error) using the weighting coefficient and the difference between the ground truth image and the output image for training. More specifically, the weight in the dark area is increased. This configuration can train a machine learning model whose estimation accuracy is not easily affected by the magnitude of the signal of the developed image.

### Example 1

A description will now be given of an image processing system 100 according to Example 1 of the present disclosure. In this example, the task of the machine learning model is to deblur a captured image. The blur to be deblurred is blur caused by aberration and diffraction that occur in the optical system, and the blur caused by an optical low-pass filter. However, the effect of this example can be similarly obtained in deblurring the blur caused by pixel aperture, defocus, and shaking. The effect of this example can also be obtained for tasks other than deblurring.

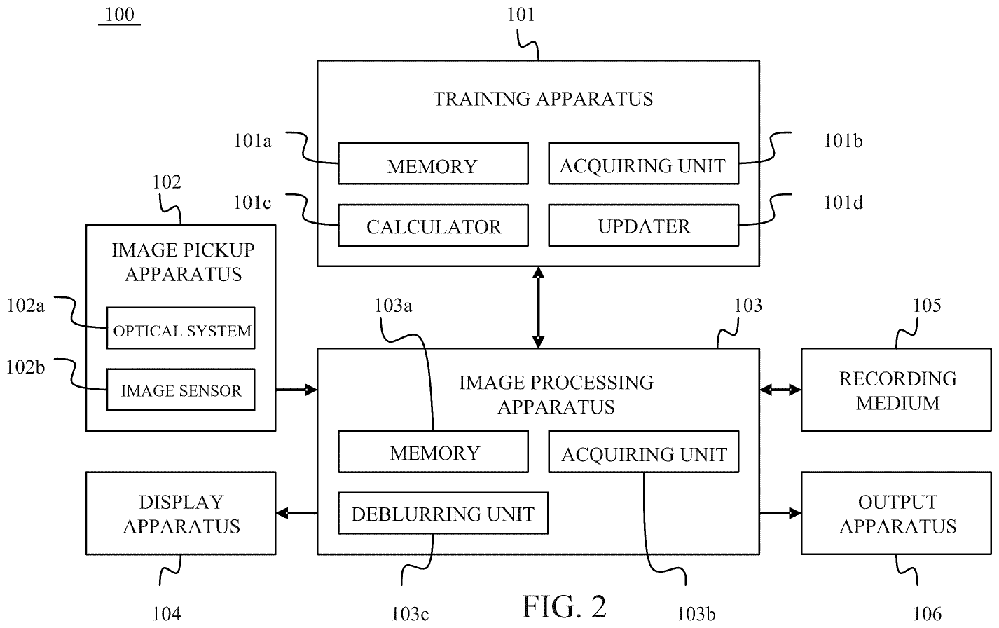

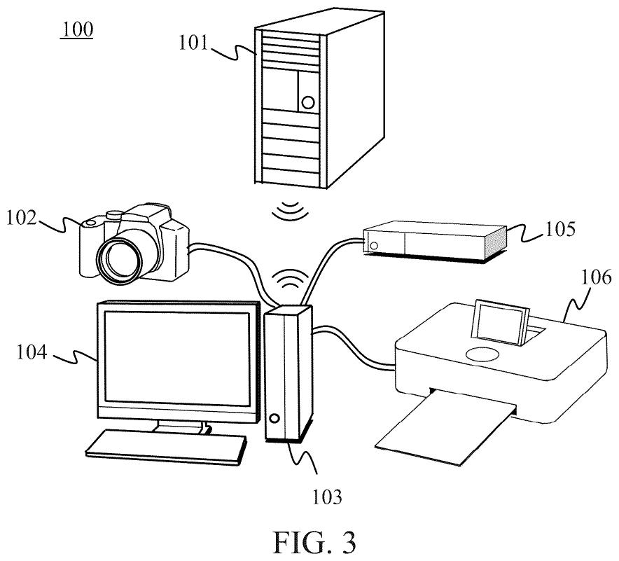

FIG. 2 is a block diagram of the image processing system 100. FIG. 3 is an external view of the image processing system 100. The image processing system 100 includes a training apparatus 101 and an image processing apparatus 103 connected by a wired or wireless network. The image processing apparatus 103 is connected to an image pickup apparatus 102, a display apparatus 104, a recording medium 105, and an output apparatus 106 by wire or wireless. A captured image of object space captured by the image pickup apparatus 102 is input to the image processing apparatus 103. The captured image is blurred due to aberration and diffraction caused by the optical system 102a in the image pickup apparatus 102 and the optical low-pass filter of the image sensor 102b, and object information is attenuated. The image processing apparatus 103 deblurs a captured image using a machine learning model to generate a deblurred image. The machine learning model is trained in the training apparatus 101, and the image processing apparatus 103 previously acquires information about the machine learning model from the training apparatus 101 and stores it in the memory 103a. The deblurred image is stored in the memory 103a or the recording medium 105, and is output to an output apparatus 106 such as a printer as necessary.

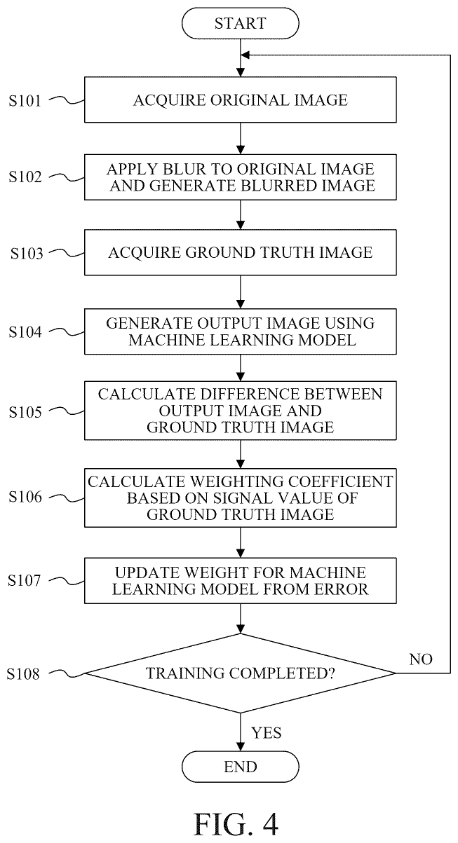

Referring now to FIG. 4, a description will be given training processing for the machine learning model (a method for generating a trained model) executed by the training apparatus (image processing apparatus) 101. FIG. 4 is a flowchart of the training processing for the machine learning model. The training apparatus 101 includes a memory 101a, an acquiring unit 101b, a calculator (generator) 101c, and an updater 101d, and any of the components executes the following steps.

First, in step S101, the acquiring unit 101b acquires one or more original images from the memory 101a. In order to train the machine learning model based on the original images, the original image may have a variety of frequency components (edges of different orientations and intensities, gradations, flat areas, etc.). The original images may be actual images or Computer Graphics (CG).

Next, in step S102, the calculator (generator) 101c adds blur to the original image to generate a blurred image. The blurred image is a training image input to the machine learning model during training, and corresponds to a captured image during estimation. The blur to be added is a blur that is a target of deblurring. In Example 1, blurs generated by the aberration and diffraction of the optical system 102a and the optical low-pass filter of the image sensor 102b are added. The shape of the blur caused by the aberration and diffraction of the optical system 102a changes according to the image plane coordinates (image height and azimuth). It also changes according to a focal length, an aperture value (F-number), and a focus state of the optical system 102a. In order to train a machine learning model that deblurs all of these blurs simultaneously, a plurality of blurred images may be generated using a plurality of blurs generated by the optical system 102a. In a case where necessary, noise generated by the image sensor 102b may be added to the blurred image.

Next, in step S103, the acquiring unit 101b acquires a ground truth image. In Example 1, since the task is deblurring, the ground truth image is an image that is less blurred than the blurred image. In Example 1, the original image is the ground truth image. In a case where the original image lacks high-frequency components, an image obtained by reducing the original image may be used as the ground truth image. In this case, reduction is also performed in generating a training image in step S102. Step S103 may be performed any time after step S101 and before step S104.

For processing other than deblurring, training processing can be executed by similarly preparing a pair of a training image and a ground truth image in simulation. As to denoising, a training image can be generated by adding expected noise to a low-noise ground truth image. As to upsampling, the training image is a low-resolution image, and the ground truth image is a high-resolution image. The training image can be prepared by downsampling the ground truth image. The training image and the ground truth image may or may not be matched in size. In a case where a training image is generated by downsampling the ground truth image by 1/n times, the size can be adjusted by stretching the training image by n times using bicubic or other interpolation. As to the removal of compression noise, a training image can be generated by compressing a ground truth image that is not compressed or has a low compression rate. It is not essential to prepare a pair of a training image and a ground truth image by simulation, and they may be prepared by actual imaging.

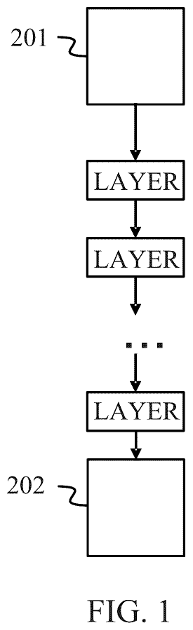

Next, in step S104, the calculator 101c generates an output image based on the training image using the machine learning model. The signal value of the output image may exceed a range that the image signal can take. Thus, in step S104, the signal value of the output image may be clipped. In a case where it is normalized, it is clipped to 0 to 1, and in a case where it is not normalized, it is clipped to an optical black signal value and a luminance saturation value. Example 1 uses, but is not limited to, the machine learning model illustrated in FIG. 1. A training image 201 is input to the machine learning model. The machine learning model has a plurality of layers, and calculates a linear sum of the input and weight of the layer in each layer. The initial value of the weight may be determined by a random number or the like. In Example 1, the machine learning model is a CNN that uses the convolution of the input and the filter as a linear sum. The value of each element of the filter corresponds to the weight. The sum with the bias may also be included. However, this example is not limited to this implementation. In each layer, nonlinear transformation is performed using an activation function such as Rectified Linear Unit (ReLU) or a sigmoid function, as necessary. The machine learning model may have a residual block or a skip connection (also called a shortcut connection) as necessary. As a result of passing through the plurality of layers, an output image 202 is generated.

Next, in step S105, the updater 101d calculates a difference between the output image 202 and the ground truth image for each pixel. That is, at this stage, the difference becomes a two-dimensional map. In this example, the updater 101d calculates difference S using the following equation (1):

$${S}_{j} = {t}_{j} - {y}_{j} \qquad ( 1 )$$

In equation (1), t is a signal value of a ground truth image, y is a signal value of the output image 202, and j is a pixel number. In equation (1), the signal value of the output image is subtracted from the signal value of the ground truth image, but the signal value of the ground truth image may be subtracted from the signal value of the output image. The difference may be calculated for the residual component. In the case of the residual component, the difference between the residual component of the output image 202 and the training image 201 and the residual component of the ground truth image and the training image 201 is used.

Next, in step S106, the updater 101d calculates (determines) a weighting coefficient based on the signal value of the normalized ground truth image, and weights the difference acquired in step S105. This example calculates (acquires) the weighting coefficient based on the signal value of the normalized ground truth image, but is not limited to this implementation. The weighting coefficient may be, for example, the signal value of the input image or the signal value of the output image. Alternatively, the weighting coefficient may be the signal value before normalization. In a case where the output image is a residual component from the training image and the ground truth image is a residual component from the training image, the weighting coefficient is calculated (obtained) based on the signal value of a first image obtained by adding the output image to the training image, or the signal value of a second image obtained by adding the ground truth image to the training image.

Thus, in this example, in a case where the output image and the ground truth image are not residuals from the training image, the weighting coefficient changes according to at least one signal value of the training image, the ground truth image, and the output image. In this example, in a case where the output image and the ground truth image are residuals from the training image, the weighting coefficient changes according to at least one signal value of the training image, the first image obtained by adding the output image to the training image, and the second image obtained by adding the ground truth image to the training image.

In this example, the weighting coefficient may be determined based on the signal value after the output image is clipped at a predetermined value (upper limit value). In this example, the weighting coefficient may change according to the signal value in the non-saturated region of each image. However, this example is not limited to this implementation, and the weighting coefficient may be changed between the saturated and non-saturated regions of the image.

In an attempt to input a raw image into the machine learning model to estimate a desired output image, the machine learning model may also be trained with the raw image. In training, the machine learning model is optimized by minimizing the error between the output obtained by inputting a training raw image into the machine learning model and the ground truth raw image. Thus, the error during training is minimized in the state of the raw image (a state in which a light amount and a signal value have an approximately linear relationship). However, in a case where a user actually views a developed output image, gamma correction is performed, and the error changes according to the magnitude of the signal value. More specifically, the error is enlarged in the dark part of the estimated image, and the estimation accuracy decreases.

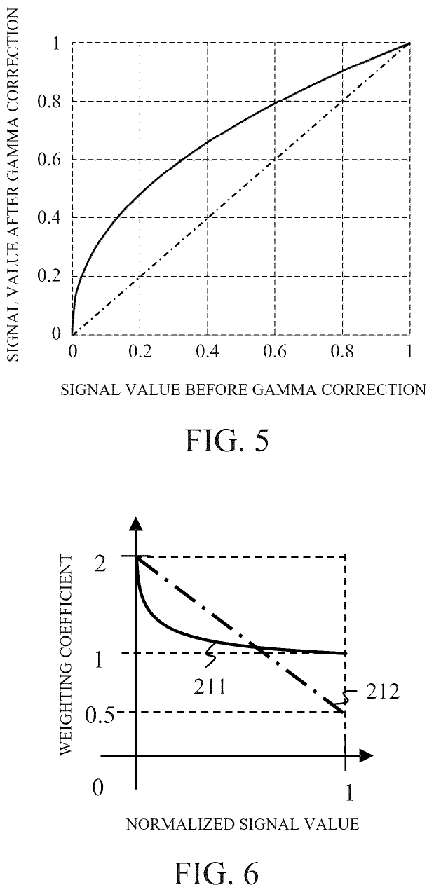

Gamma correction is processing in which the curve illustrating a relationship between the signal values before and after correction (a gamma curve illustrated by a solid line in FIG. 5) is at a position above a straight line with a slope of 1 (an alternate long and short dash line in FIG. 5), as illustrated in FIG. 5. FIG. 5 explains gamma correction. In FIG. 5, a horizontal axis represents a signal value before gamma correction, and a vertical axis represents a gamma-corrected signal value.

A specific example of function g representing gamma correction is given in the following equation (2):

$$g ( s ) = {S}^{1 / γ} \qquad ( 2 )$$

In equation (2), s is a normalized signal value before gamma correction, and γ (>1) is a constant. However, gamma correction is not limited to the form of equation (2).

In order to suppress an error in the dark area in training the machine learning model, a weighting coefficient is calculated based on the signal value of the ground truth image, and the error is calculated from the weighting coefficient and a difference between the ground truth image and the output image, and training is performed. Thereby, the machine learning model can be trained so as to further suppress an error in areas with large weighting coefficients.

FIG. 6 illustrates a relationship (relational expression) between a normalized signal value of a ground truth image and a weighting coefficient given to a difference. In FIG. 6, a horizontal axis represents the normalized signal value, and a vertical axis represents the weighting coefficient. As illustrated by a solid line 211, the smaller the normalized signal value of the ground truth image is, the larger the weighting coefficient given to the difference is. The solid line 211 reflects the characteristic of gamma correction that magnifies the signal value on the dark side, and the weighting coefficient is set to be larger on the darker side.

The solid line 211 is not limited to the solid line, and any relational expression that makes the weighting coefficient on the dark side larger than on the light side may be set freely, such as an alternate long and short dash line 212. In this case, in a case where the normalized signal value is 0, the weighting coefficient 2 is multiplied by the difference calculated in step S105, and in a case where the normalized signal value is 1, the weighting coefficient 0.5 is multiplied by the weighting coefficient.

Instead of calculating the weight corresponding to the signal value using a function, the weight corresponding to the signal value may be stored as a table. In the case of a signal value that is not in the table, it may be created using interpolation from the weighting coefficients corresponding to the stored signal values before and after it. In addition to gamma correction, in a case where an arbitrary signal value conversion processing is performed for the estimated image of the machine learning model, the weighting coefficient may be determined according to the characteristic of the signal value conversion processing.

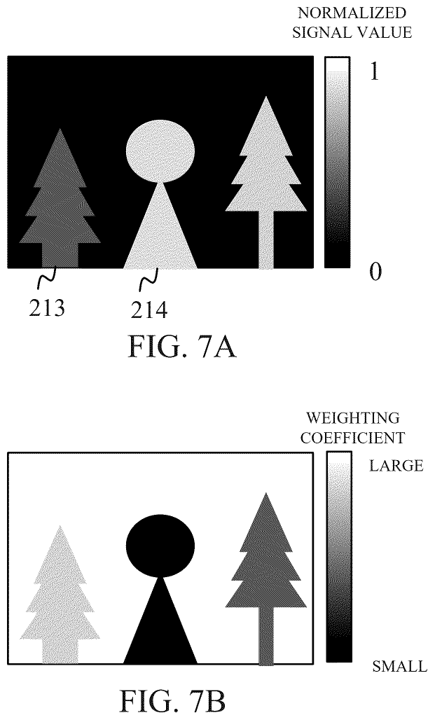

FIG. 7A illustrates an example of the signal value of the normalized ground truth image, and FIG. 7B illustrates an example of the weighting coefficient given to the difference. Objects 213 and 214 have different normalized signal values, and the object 213 has a smaller signal value. Therefore, the weighting coefficient given to the difference is different, and the weighting coefficient given to the difference is larger in the area corresponding to the object 213. The above weighting coefficient is calculated for each pixel of the difference obtained in step S105, and final error L1 can be expressed by the following equation (3):

$$L 1 = \frac{1}{N} {\sum }_{j}^{N} {\vert W {1}_{j} * ( {t}_{j} - {y}_{j} ) \vert}^{2} \qquad ( 3 )$$

In equation (3), N is the total number of pixels, and W1 is a weighting coefficient. Equation (3) uses Mean Squared Error (MSE) for the error, but another index may be used as long as it represents the error between the ground truth image and the output image. Example 1 calculates a difference between the ground truth image and the output image and multiplies a difference by the weighting coefficient, but the order of processing is not limited to this example. For example, the updater 101d may calculate a weighting coefficient for each of the ground truth image and the output image, multiply the ground truth image and the output image, and calculate the error by calculating the difference between the two differences.

Next, in step S107 of FIG. 4, the updater 101d updates the parameter of the machine learning model based on the error. Updating the parameter may use backpropagation or the like.

Next, in step S108, the updater 101d determines whether the training of the machine learning model is completed. Completion can be determined by determining whether the number of iterations of parameter update has reached a predetermined number, whether a change amount in the parameter during updating is smaller than a predetermined value, or the like. In a case where it is determined in step S108 that the training has not been completed, the flow returns to step S101, and the acquiring unit 101b acquires one or more new original images. On the other hand, in a case where it is determined that the training has been completed, the updater 101d terminates the training and stores the configuration of the machine learning model and parameter information in the memory 101a.

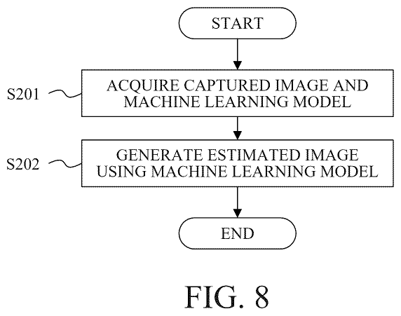

Referring now to FIG. 8, a description will be given of the deblurring of a captured image using a trained machine learning model (machine learning model estimation processing) executed by the image processing apparatus 103. FIG. 8 is a flowchart of the machine learning model estimation processing. The image processing apparatus 103 includes a memory 103a, an acquiring unit 103b, and a deblurring unit 103c, and any of these components executes the following steps.

First, in step S201, the acquiring unit 103b acquires a captured image and a machine learning model. Information on the configuration and parameter of the machine learning model is acquired from the memory 103a.

Next, in step S202, the deblurring unit 103c uses the machine learning model to generate a deblurred image (estimated image) in which the captured image has been deblurred. The machine learning model has the configuration illustrated in FIG. 1, as in training.

Next follows a description of conditions for increasing the effect of this example. First, the step for normalizing the signal values of the input image and the ground truth image to be input to the machine learning model may be provided. The captured image has a different range of possible image signal values according to the configuration of the image pickup apparatus. In a case where the signal value range in the input image differs between the training processing and the estimation processing, a correct estimation result cannot be obtained. Thus, the signal value may be normalized. The range which signal values can take is defined by a lower limit (optical black signal value) and an upper limit (luminance saturation value). Information on the signal value range can be obtained from the header of the captured image or the optical black area.

In addition, the weighting coefficient may be based on at least one signal value of the training image, the ground truth image or the second image, the output image or the first image after white balance adjustment. In a case where a user views a developed output image, not only gamma correction but also white balance processing is performed, so if a raw image is trained without considering white balance processing, the color balance may differ from that during development.

The above configuration can provide an image processing method capable of obtaining a machine learning model whose estimation accuracy is less likely to be affected by the magnitude of a signal of a developed image.

### Example 2

Next follows a description of an image processing system 300 according to Example 2 of the present disclosure. In this example, in addition to the signal value of the ground truth image, a weighting coefficient is calculated based on the magnitude relationship between the signal values of the ground truth image and the output image.

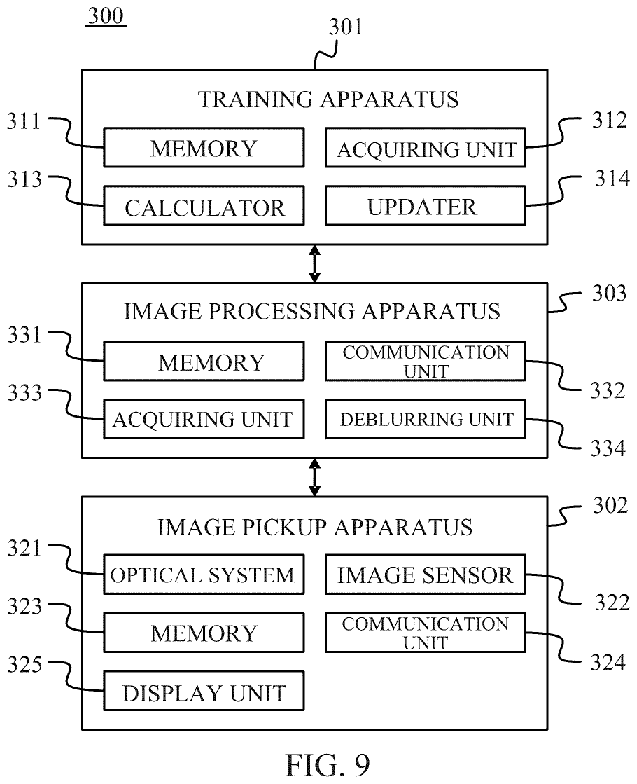

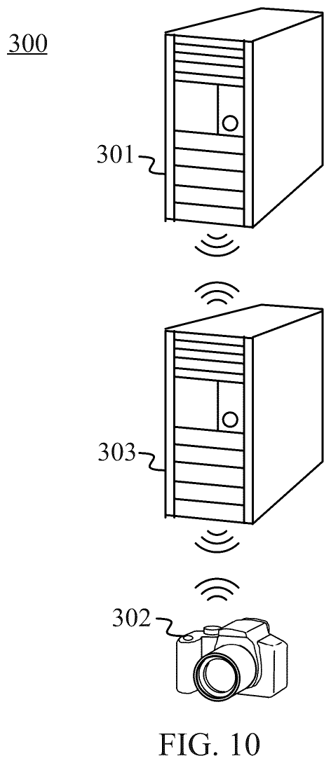

FIG. 9 is a block diagram of the image processing system 300. FIG. 10 is an external view of the image processing system 300. The image processing system 300 includes a training apparatus 301, an image pickup apparatus 302, and an image processing apparatus 303. The training apparatus 301 and the image processing apparatus 303, and the image processing apparatus 303 and the image pickup apparatus 302 are each connected by a wired or wireless network. The image pickup apparatus 302 includes an optical system 321, an image sensor 322, a memory 323, a communication unit 324, and a display unit 325. The captured image is transmitted to the image processing apparatus 303 via the communication unit 324. The image processing apparatus 303 receives the captured image via the communication unit 332, and deblurs it using the sharpening unit 334 and the information on the configuration and parameter of the machine learning model stored in the memory 331. The information on the configuration and parameter of the machine learning model is trained by the training apparatus 301, and is previously acquired from the training apparatus 301 and stored in the memory 331.

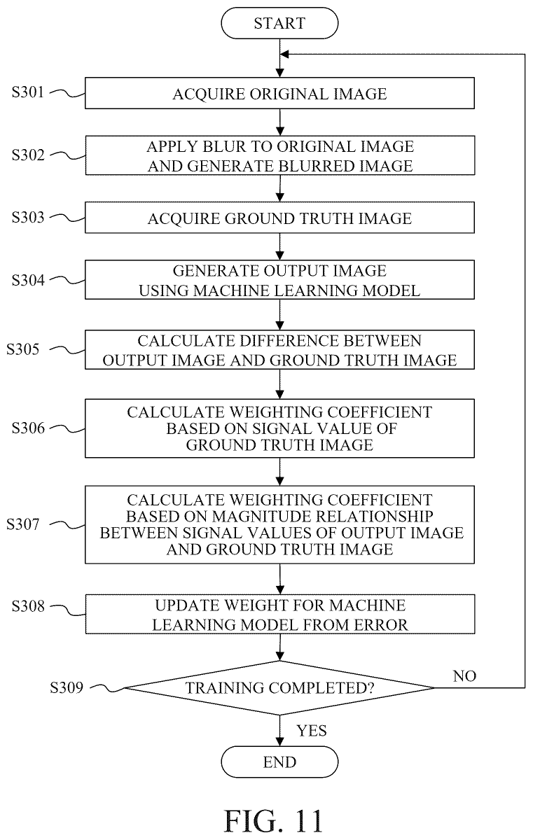

Referring now to FIG. 11, a description will be given of the training processing for the machine learning model executed by the training apparatus 301 (a method of generating a trained model). FIG. 11 is a flowchart of the training processing for the machine learning model according to this example. Steps S301 to S306, S308, and S309 in FIG. 11 are similar to steps S101 to S108 in FIG. 4 described in Example 1, respectively, and thus a detailed description thereof will be omitted.

In step S301, the acquiring unit 312 acquires one or more original images from the memory 311. Next, in step S302, the calculator 313 applies blur to the original image to generate a blurred image. Next, in step S303, the acquiring unit 312 acquires a ground truth image. Next, in step S304, the calculator 313 uses a machine learning model to generate an output image based on the training image. Next, in step S305, the updater 314 calculates a difference between the output image and the ground truth image for each pixel. Next, in step S306, the updater 314 calculates a weighting coefficient based on the normalized signal value of the ground truth image.

Next, in step S307, the updater 314 calculates a weighting coefficient based on the magnitude relationship between the signal values of the ground truth image and the output image. In this example, in addition to the weighting coefficient based on the signal value of the ground truth image, the weighting coefficient is calculated based on the magnitude relationship between the signal values of the ground truth image and the output image. This effect will be discussed using specific numerical values.

For example, assume pixels A and B having normalized signal values of the ground truth image are both 0.1. At this time, in a case where the signal values of pixels A and B in the output image of the machine learning model are 0.05 and 0.15, respectively, a difference between them and the ground truth image is the same, 0.05. However, the difference between pixel A, which is located on the darker side, and the ground truth image is enlarged by gamma correction during development. More specifically, in a case where 1/2.2 is used as the exponent for gamma correction, the signal value of the ground truth image after gamma correction is 0.35, and the pixel values of pixels A and B after gamma correction are 0.26 and 0.42, respectively, and the difference is 0.09 and 0.07. Therefore, this step compares the signal values of the ground truth image and the output image, and increases the weighting coefficient in an area where the signal value of the ground truth image is large. That is, the weighting coefficient in an area where the signal value of the ground truth image is larger than that of the output image is larger than the weighting coefficient in an area where the signal value of the ground truth image is smaller than that of the output image.

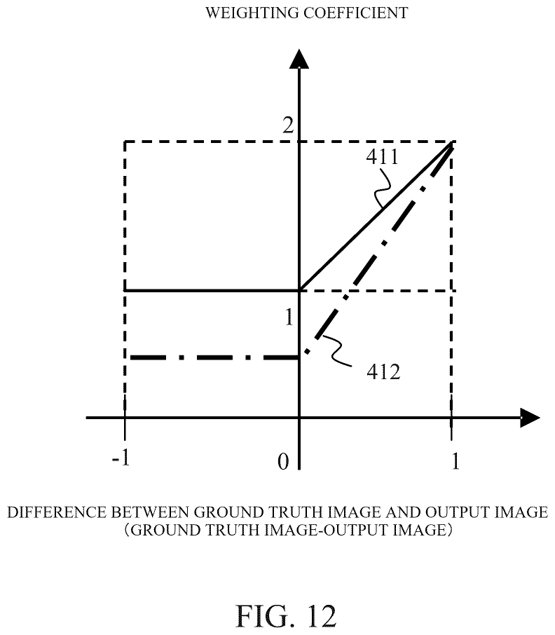

FIG. 12 illustrates a relationship (relational expression) between the difference between the ground truth image and the output image and the weighting coefficient. In FIG. 12, a horizontal axis represents a difference between the ground truth image and the output image, and a vertical axis represents a weighting coefficient. As illustrated by a solid line 411, the weighting coefficient is increased in an area where the signal value of the ground truth image is larger than that of the output image. The relational expression is not limited to the solid line 411 and may be set freely. As long as the relational expression increases the weighting coefficient in an area where the signal value of the ground truth image is larger than that of the output image, the relational expression may be illustrated as in an alternate long and short dash line 412. The weighting coefficient corresponding to the difference between the ground truth image and the output image may be stored as a table. Although the horizontal axis in FIG. 12 represents a value obtained by subtracting a signal value of an output image from a signal value of a ground truth image, the horizontal axis may also represent a value obtained by subtracting a signal value of an output image from a signal value of a ground truth image. In this case, as to the solid line 411 and the dashed line 412, left and right are reversed. Using the weighting coefficient calculated in steps S306 and S307, final error L2 can be expressed by the following equation (4):

$$L 2 = \frac{1}{N} {\sum }_{j}^{N} {\vert W {2}_{j} * W {1}_{j} * ( {t}_{j} - {y}_{j} ) \vert}^{2} \qquad ( 4 )$$

In equation (4), t is a signal value of the ground truth image, y is a signal value of the output image 202, j is a pixel number, N is a total number of pixels, W1 is a weighting coefficient calculated in step S306, and W2 is a weighting coefficient calculated in step S307.

Next, in step S308 of FIG. 11, the updater 314 updates the parameter of the machine learning model based on the error. Next, in step S309, the updater 314 determines whether training of the machine learning model has been completed.

The deblurring of the captured image using the trained machine learning model executed by the image processing apparatus 303 is similar to that in Example 1, and thus a description thereof will be omitted.

The above configuration can provide an image processing method that can acquire a machine learning model whose estimation accuracy is less likely to be affected by the signal magnitude of the developed image.

In each example, the training image, the output image, and the ground truth image are images that have not yet received gamma correction as described with reference to FIG. 5, but this example is not limited to this implementation. Each example may calculate an error using a gamma-corrected image and a weighting coefficient.

At this time, the calculator 101c executes gamma correction on each of the ground truth image and the output image. The acquiring unit 101b acquires information on the gamma correction for the training processing. Combining the gamma correction for the training processing with the gamma correction for developing the estimated image can estimate with a more stable accuracy that does not depend on the magnitude of the gamma-corrected signal value. In each example, in order to support a variety of gamma corrections, the training apparatus 101 executes training processing for each of a plurality of gamma corrections, and stores the network parameter optimized for each gamma correction in the memory 101a. Information on the gamma correction can be acquired by selecting from information on the plurality of gamma corrections stored in the memory 101a, or the user may input a gamma correction equation or a lookup table.

Next, the updater 101d calculates an error between the gamma-corrected ground truth image and the gamma-corrected output image using the gamma-corrected ground truth image, the gamma-corrected output image, and the weighting coefficient. Thereby, the estimation accuracy can be improved.

According to each example, the above configuration can provide an image processing method, a trained-model generating method, an image processing apparatus, and a storage medium, each of which can provide a machine learning model whose estimation accuracy is less likely to be affected by a signal magnitude of a developed image.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-133782, which was filed on Aug. 9, 2024, and which is hereby incorporated by reference herein in its entirety.

What is claimed is:

1. A method for generating a trained model, the method comprising:
acquiring a training image and a ground truth image;
inputting the training image into a machine learning model to generate an output image;
acquiring a weighting coefficient;
calculating a loss using the ground truth image, the output image, and the weighting coefficient; and
updating a parameter of the machine learning model based on the loss,
wherein the weighting coefficient changes according to at least one of a signal value of the training image, a signal value of the ground truth image, and a signal value of the output image.

2. A method for generating a trained model, the method comprising:
acquiring a training image and a ground truth image;
inputting the training image into a machine learning model to generate an output image;
acquiring a weighting coefficient,
calculating a loss using the ground truth image, the output image, and the weighting coefficients; and
updating a parameter of the machine learning model based on the loss,
wherein the weighting coefficient changes according to at least one of a signal value of the training image, a signal value of a first image acquired by adding the output image to the training image, and a signal value of a second image acquired by adding the ground truth image to the training image.

3. The method according to claim 1, wherein the weighting coefficient changes according to the at least one in a non-saturated region of each image.

4. The method according to claim 1, wherein the loss is calculated by using a difference between the ground truth image and the output image, and the weighting coefficient.

5. The method according to claim 4, wherein the loss is a difference calculated with the weighting coefficient.

6. The method according to claim 1, wherein the training image, the output image, and the ground truth image are not gamma-corrected images.

7. The method according to claim 1, wherein the weighting coefficient in a region where the signal value of the ground truth image is larger than the signal value of the output image is larger than the weighting coefficient in a region where the signal value of the ground truth image is smaller than the signal value of the output image.

8. The method according to claim 1, wherein the weighting coefficient increases as the signal value of the ground truth image decreases.

9. The method according to claim 2, wherein the weighting coefficient increases as the signal value of the second image decreases.

10. The method according to claim 1, wherein the weighting coefficient is determined based on the signal value of the output image that has been clipped by a predetermined value.

11. The method according to claim 1, wherein the weighting coefficient is determined using a signal value acquired by normalizing the at least one.

12. The method according to claim 1, wherein the weighting coefficient is determined using a signal value acquired by performing white balance adjustment for the at least one.

13. The method according to claim 1, wherein the output image is a high-resolution image of the training image.

14. The method according to claim 2, wherein the output image is a residual between the training image and a high-resolution image of the training image.

15. The method according to claim 1, further comprising:
performing gamma correction for each of the ground truth image and the output image,
wherein calculating the loss calculates the loss using a gamma-corrected ground truth image, a gamma-corrected output image, and the weighting coefficient.

16. An image processing method using the trained model acquired by the method according to claim 1, the image processing method comprising:
generating an estimated image based on an input image,
wherein the estimated image is generated using the trained model.

17. An image processing method using the trained model acquired by the method according to claim 2, the image processing method comprising:
generating an estimated image based on an input image,
wherein the estimated image is generated using the trained model.

18. An image processing apparatus comprising:
one or more memories storing instructions; and
one or more processors that, upon execution of the instructions, operate to:
acquire a training image, a ground truth image, and a weighting coefficient,
input the training image into a machine learning model to generate an output image,
calculate a loss using the ground truth image, the output image, and the weighting coefficient, and
update a parameter of the machine learning model based on the loss,
wherein the weighting coefficient changes according to at least one of a signal value of the training image, a signal value of the ground truth image, and a signal value of the output image.

19. An image processing apparatus comprising:
one or more memories storing instructions; and
one or more processors that, upon execution of the instructions, operate to:
acquire a training image, a ground truth image, and a weighting coefficient,
input the training image into a machine learning model to generate an output image,
calculate a loss using the ground truth image, the output image, and the weighting coefficient, and
update a parameter of the machine learning model based on the loss,
wherein the weighting coefficient changes according to at least one of a signal value of the training image, a signal value of a first image acquired by adding the output image to the training image, and a signal value of a second image acquired by adding the ground truth image to the training image.

20. A non-transitory computer-readable storage medium storing a program that causes a computer to execute the method according to claim 1.
